(19) United States
(12) Patent Application Publication
(10) Pub. No.: US 2026/0323711 A1
(43) Pub. Date: Oct. 15, 2026

(54) ASSOCIATION BETWEEN SYNCHRONIZATION SIGNAL BLOCK AND PHYSICAL RANDOM ACCESS CHANNEL OCCASION GROUP FOR MULTIPLE PRACH TRANSMISSIONS

(71) Applicant: Intel Corporation, Santa Clara, CA (US)

(72) Inventors: Gang Xiong, Portland, OR (US); Debdeep Chatterjee, San Jose, CA (US); Dae Won Lee, Portland, OR (US)

(73) Assignee: Intel Corporation, Santa Clara, CA (US)

(21) Appl. No.: 19/483,088

(22) PCT Filed: Jun. 12, 2024
(86) PCT No.: PCT/US2024/033588

§ 371 Date: Nov. 10, 2025

Related U.S. Application Data
(60) Provisional application No. 63/509,727, filed on Jun. 22, 2023.

(51) Int. Cl. H04W 74/0833; H04L 5/00

(52) U.S. Cl. CPC H04W 74/0833; H04L 5/0005

(57) ABSTRACT

An apparatus of a New Radio (NR) User Equipment (UE), includes the processing circuitry to: detect a synchronization signal block (SSB) from a NR Node B (gNB); determine a number of multiple physical random access channel (PRACH) transmissions, wherein respective PRACH transmissions of the multiple PRACH transmissions correspond to repetitions of each other and to a preamble; determine a set of valid PRACH occasions associated with the SSB, wherein respective ones of the valid PRACH occasions of the set: are in sequential respective time instances; and use same frequency resources as any immediately prior PRACH occasion of the set; and send the multiple PRACH transmissions in the set for transmission to the gNB.

### CROSS REFERENCE TO RELATED APPLICATIONS

This application claims the benefit of and priority from U.S. Provisional Patent Application No. 63/509,727 entitled “Association Between SSB And PRACH Occasion Group For Multiple PRACH transmissions” filed Jun. 22, 2023 the entire disclosure of which is incorporated herein by reference.

### BACKGROUND

Various embodiments generally relate to the field of cellular communications, and particularly to concepts related to Random Access Channel (RACH) transmissions.

### BRIEF DESCRIPTION OF THE DRAWINGS

FIG. 1 illustrates a four step RACH procedure for initial access according to the Third Generation Partnership Project's (3GPP's) New Radio (NR) Release 15 procedures.

FIG. 2 illustrates one example of synchronization signal block (SSB) to physical RACH (PRACH) group (RO) association signalling diagram for multiple PRACH transmissions based on some embodiments.

FIG. 3 illustrates another example of synchronization signal block (SSB) to physical RACH (PRACH) group (RO) association signalling diagram for multiple PRACH transmissions based on some embodiments.

FIG. 4 illustrates yet another example of synchronization signal block (SSB) to physical RACH (PRACH) group (RO) association signalling diagram for multiple PRACH transmissions based on some embodiments.

FIG. 5 illustrates a network that is to operate in a manner consistent with Third Generation Partnership Project (3GPP) technical specifications for Long Term Evolution (LTE) or Fifth Generation/New Radio (5G/NR) systems.

FIG. 6 illustrates a wireless network in accordance with various embodiments.

FIG. 7 illustrates a block diagram of components, according to some example embodiments, able to read instructions from a machine-readable or computer-readable medium.

FIG. 8 illustrates a network in accordance with various embodiments, where the network may operate in a manner consistent with 3GPP technical specifications or technical reports for 6G systems.

FIG. 9 illustrates a process according to one embodiment.

FIG. 10 illustrates a process according to another embodiment.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Mobile communication has developed from the basic voice call systems to today's complex integrated communication platforms. The next generation of wireless communication, known as 5G or new radio (NR), is poised to offer ubiquitous access to information and enable data sharing anytime and anywhere by various users and applications. NR aims to be a comprehensive network/system designed to accommodate a wide range of performance dimensions and services, often with varying and sometimes conflicting requirements. These diverse needs are fueled by different services and applications. NR is expected to evolve from the 3rd Generation Partnership Project (3GPP) Long Term Evolution-Advanced (LTE-Advanced) and may incorporate additional potential new Radio Access Technologies (RATs). These enhancements are intended to enrich people's lives by providing better, simpler, and seamless wireless connectivity solutions. Essentially, NR aims to enable a fully connected world through wireless technology, facilitating fast and rich content and services.

For cellular systems, coverage is an important factor for successful operation. Compared to LTE, NR can be deployed at relatively higher carrier frequency in frequency range 1 (FR1), e.g., at 3.5 GHz. In this case, coverage loss is expected due to larger path-loss, which makes it more challenging to maintain an adequate quality of service. Typically, uplink coverage is the bottleneck for system operation considering the low transmit power at the User Equipment (UE) side.

In NR Release 15 (Rel-15), a 4-step procedure was defined for random access channel (RACH).

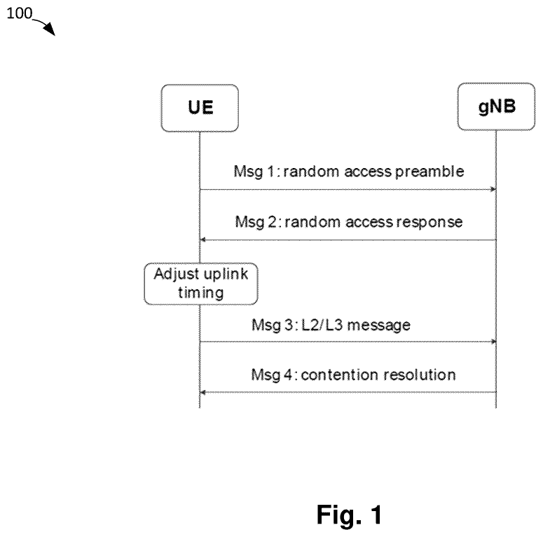

FIG. 1 illustrates the 4-step random RACH procedure for initial access according to Rel-15. In the first step, the UE transmits in Msg 1 a physical random access channel (PRACH) in the uplink by randomly selecting one preamble signature, which would allow the evolved Node B (gNB) to estimate the delay between the gNB and the UE for any subsequent uplink (UL) timing adjustment. Subsequently, in the second step, the gNB feedbacks the random access response (RAR) in Msg 2, which carries timing advanced (TA) command information and an uplink grant for the uplink transmission to happen in the third step. The UE expects to receive the RAR within a time window, of which the start and end are configured by the gNB via system information block (SIB).

To improve the coverage and performance, according to some embodiments multiple PRACH transmissions from a UE can be supported, where a same preamble (i.e., including same Zuboff-Chu sequence) may be used for the PRACH repetitions in different time locations within the time domain. When multiple numbers of multiple PRACH transmissions are configured on the gNB side (i.e., different sets of PRACH repetitions with each set having a number of PRACH repetitions), the number of multiple PRACH transmissions can be determined by a given UE based on the measured Reference Signal Received Power (RSRP) at that UE and configured synchronization signal block (SSB)-RSRP thresholds. Subsequently, the UE can select the corresponding PRACH occasion (RO) groups for multiple PRACH transmissions (PRACH repetitions) from the UE according to the determined number of multiple PRACH transmissions at the UE side.

In this case, the association between SSB and RO group may need to be defined for proper operation for multiple PRACH transmissions. An RO group refers to a group of ROs that are associated with a same SSBs, with each RO of a given RO group corresponding to a PRACH repetition.

Various embodiments herein provide mechanisms for the association between SSB and RO group for multiple PRACH transmissions. For example, aspects of various embodiments herein may include:
Determination of a set of RO groups for multiple PRACH transmissions
Association pattern time period determination for RO groups for multiple PRACH transmission
PRACH mask for multiple PRACH transmissions

Embodiments may advantageously improve NR PRACH coverage, and resulting performance, among other benefits.

### Determination of a Set of RO Groups for Multiple PRACH Transmissions

As mentioned above, to improve the coverage, multiple PRACH transmissions can be supported, where same preamble is used for the PRACH repetitions in different time locations. When a multiple number of multiple PRACH transmissions (repetitions) are configured, the number of multiple PRACH transmissions can be determined based on the measured Reference Signal Received Power (RSRP) and configured synchronization signal block (SSB)-RSRP thresholds. Subsequently, the UE can select the corresponding PRACH occasion (RO) groups for the multiple PRACH transmissions according to the determined number of multiple PRACH transmissions. In this case, the association between SSB and RO group may need to be defined for proper operation for multiple PRACH transmissions.

In the following embodiments, the terms “repetition level,” “number of repetitions,” “number of multiple PRACH transmissions” are exchangeable. In addition, the terms “PRACH occasion (RO) group,” “RO set,” “a set of ROs for multiple PRACH transmissions” are exchangeable.

Embodiments of determination of a set of RO groups for multiple PRACH transmissions are provided as follows:

In one embodiment, for multiple PRACH transmissions, the determination of a given RO group of a number of ROs that are associated with an SSB, starting from frame 0, can be defined in the following steps:
Step 1: if only one valid RO is associated with an SSB in a time instance, the RO is determined as a first RO in a first RO group; if more than one valid ROs associated with an SSB are multiplexed in a frequency division multiplexing (FDM) manner, the RO with smallest or largest index is determined as a first RO in a first RO group. In some aspects, the RO with smallest or largest index in frequency domain indicates that the RO with lowest resource or highest resource in frequency domain.
Step 2: if next available valid RO is associated with the same SSB and in a different time instances from the first RO, and if there is no other ROs that are multiplexed in a FDM manner with the next available valid RO, the next available valid RO is determined as a second RO in the first RO group; if more than one ROs that are associated with the same SSB and in a different time instances from the first RO are multiplexed in a FDM manner, the following options can be applied to determine a second RO in the first RO group
   Option 1: the valid RO with the smallest RO index is determined as a second RO in the first RO group.
   Option 2: the valid RO with smallest or largest distance in frequency domain with the first RO is determined as a second RO in the first RO group, where the smallest or largest distance in frequency domain may be interpreted as the smallest or largest RO index difference in frequency domain. If more than one valid ROs have same smallest or largest distance in frequency domain from the first RO, the valid RO with smallest or largest RO index may be determined as a second RO in the first RO group.
Step 3: the procedure in Step 1 and Step 2 above is continued to determine all the ROs in the first RO group associated with the SSB, until the number of determined valid ROs is equal to the number of repetitions for multiple PRACH transmissions.
Step 4: the procedure in Step 1 and Step 3 is continued to determine all the ROs in the second RO group associated with the SSB, assuming that the valid ROs in the first RO group are excluded from the determination of ROs in the second RO group.
Step 5: the procedure in Step 1 to Step 4 is continued to determine all the ROs in the set of RO groups associated with the SSB within the SSB to RO group association pattern period.

Equivalently, given an SSB, the associated ROs to be used for transmissions of a number of PRACH repetitions (‘k’), represented by the m-th “RO group” associated with the SSB (with m≥1), may be determined by identifying a number (‘k’) of valid ROs associated with the SSB, where the ROs identified in previous (m−1) RO groups are excluded, by selecting valid ROs associated with the SSB in increasing order of time instances (starting symbols/slots) from frame 0, such that if, at a given time instance, there exists multiple valid ROs associated with the SSB that are multiplexed in frequency domain, a single valid RO associated with the SSB with the lowest or highest index within the number of frequency multiplexed ROs is selected.

Note that the above corresponds to Option 1 for Step 2 in the description above. For Option 2 for Step 2, the equivalent description could be modified to distinguish selection of the ROs for the first and subsequent RO groups starting from frame 0.

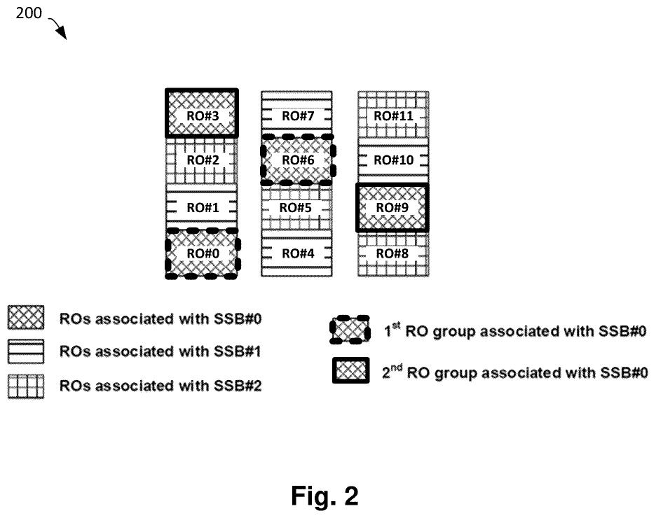

FIG. 2 illustrates one example of SSB to RO group association signalling diagram 200 for multiple PRACH transmissions based on some embodiments. In the example of FIG. 2, the number of SSBs is 3, and the number of ROs which are multiplexed in a frequency division multiplexed (FDM) manner is 4. Further, SSB to RO mapping ratio is 1 for single PRACH transmissions, which indicates that 1 SSB is associated with 1 RO (i.e., 1 PRACH occasion per one RO per one SSB). In this case, RO #0, 3, 6, 9 are associated with SSB #0, RO #1, 4, 7, 10 are associated with SSB #1 and RO #2, 5, 8, 11 are associated with SSB #2. Based on this option, if the number of multiple PRACH transmissions is 2, RO #0 and #6 are formed as a first RO group; and RO #3 and #9 are grouped as a second RO group that are associated with SSB #0 for multiple PRACH transmissions.

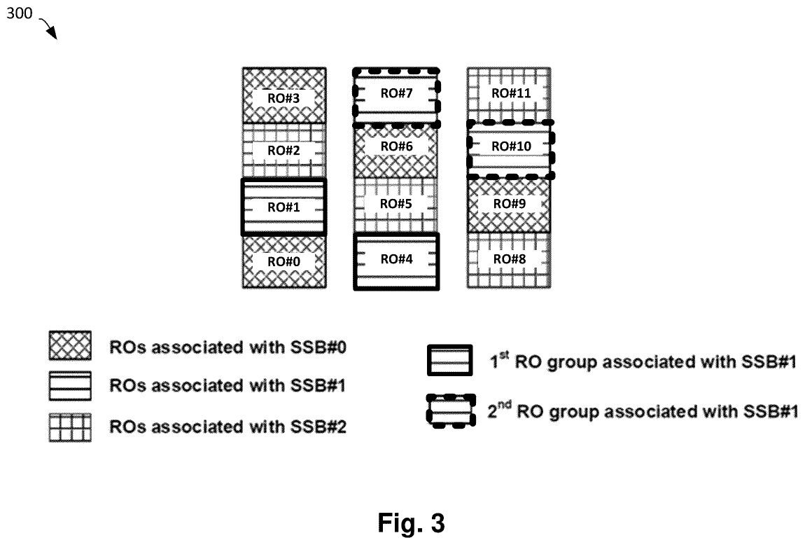

FIG. 3 illustrates one example of SSB to RO group association signalling diagram 300 for multiple PRACH transmissions according to another embodiment. In the example of FIG. 3, the number of SSBs is 3, and the number of ROs which are multiplexed in a FDM manner is 4. Further, SSB to RO mapping ratio is 1 for single PRACH transmissions, which indicates that 1 SSB is associated with 1 RO (i.e., 1 PRACH occasion per one RO per one SSB). In this case, RO #0, 3, 6, 9 are associated with SSB #0, RO #1, 4, 7, 10 are associated with SSB #1 and RO #2, 5, 8, 11 are associated with SSB #2. In this example, for ROs associated with SSB #1, the number of multiple PRACH transmissions is 2, RO #1 and #4 are formed as a first RO group; and RO #7 and #10 are grouped as a second RO group that are associated with SSB #1 for multiple PRACH transmissions. Note that in the example, the second RO (RO #4) in the first RO group is determined based on the smallest RO distance from the first RO in the first RO group, e.g., RO #1.

In another embodiment, the number of RO groups associated with an SSB in frequency domain may be determined in accordance with the smallest number of ROs in a given time instance that are associated with the same SSB. In this case, the ROs with RO index associated with an SSB that are larger than the smallest number of ROs in a given time instance are not included in a RO group associated with the SSB. Further, the aforementioned embodiment can be used to determine the set of RO groups associated with the SSB within SSB to RO group association pattern period.

In some aspects of embodiments, the number of RO groups associated with an SSB that can be multiplexed in a FDM manner is equal to the smallest number of ROs in a given time instance.

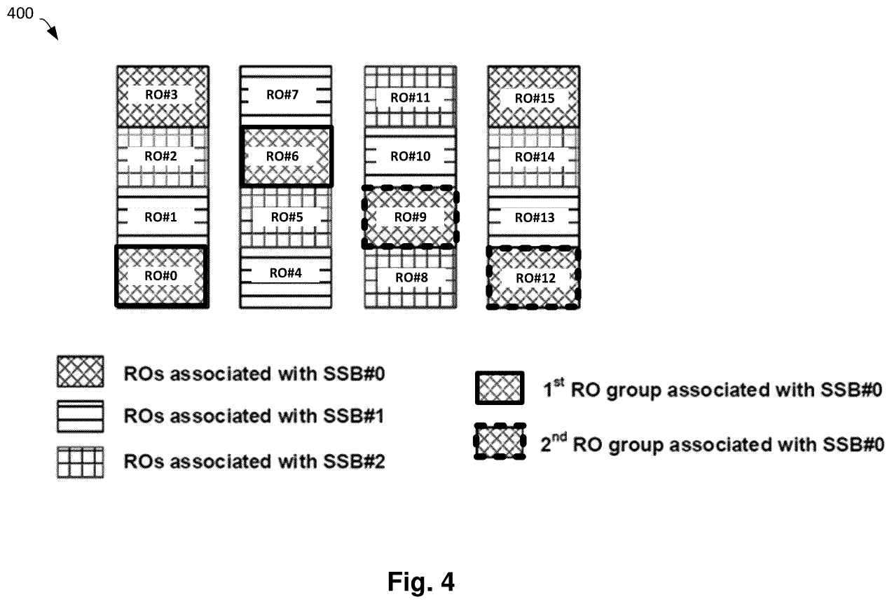

FIG. 4 illustrates one example of SSB to RO group association signalling diagram 400 for multiple PRACH transmissions according to yet another embodiment. In the example, the number of SSBs is 3, and the number of ROs which are multiplexed in a FDM manner is 4. Further, SSB to RO mapping ratio is 1 for single PRACH transmissions, which indicates that 1 SSB is associated with 1 RO (i.e., 1 PRACH occasion per one RO per one SSB). In this case, RO #0, 3, 6, 9 are associated with SSB #0, RO #1, 4, 7, 10 are associated with SSB #1 and RO #2, 5, 8, 11 are associated with SSB #2. For this option, the smallest number of ROs associated with SSB #0 for a given time instance is 1. In this case, RO #3 and #15 are not included in a RO group associated with SSB #0. In this case, if the number of multiple PRACH transmissions is 2, RO #0 and #6 are formed as a first RO group; and RO #9 and #12 are grouped as a second RO group that are associated with SSB #0 for multiple PRACH transmissions.

### Association Pattern Period Determination for RO Groups for Multiple PRACH Transmission

Various embodiments provide techniques for association pattern period determination for RO groups for multiple PRACH transmission.

In one embodiment, association pattern period for multiple PRACH transmissions is determined as K SSB to RO association pattern periods, where K is determined as the number of multiple PRACH transmissions. If more than one number of multiple PRACH transmissions is configured by gNB, different K values are determined for different number of multiple PRACH transmissions.

In one example, if 2 and 4 repetitions are configured for multiple PRACH transmissions, SSB to RO group association pattern period is equal to 2 SSB to RO association pattern periods in case of 2 repetitions; while SSB to RO group association pattern period is equal to 4 SSB to RO association pattern periods in case of 4 repetitions.

In another embodiment, association pattern period for multiple PRACH transmissions is determined as K SSB to RO association pattern periods, where K is determined as smallest or largest value among the number of multiple PRACH transmissions that is configured by the network.

In one example, if 2 and 4 repetitions are configured for multiple PRACH transmissions, SSB to RO group association pattern period is equal to 2 SSB to RO association pattern periods.

In another example, if 2 and 4 repetitions are configured for multiple PRACH transmissions, SSB to RO group association pattern period is equal to 4 SSB to RO association pattern periods.

In another embodiment, association pattern period for multiple PRACH transmissions is determined as K SSB to RO association pattern periods, where K is determined as smallest or largest value among the number of multiple PRACH transmissions that is supported in the specification.

In one example, SSB to RO group association pattern period is equal to 2 SSB to RO association pattern periods, regardless of number of multiple PRACH transmissions that is configured by the network.

In another example, SSB to RO group association pattern period is equal to 8 SSB to RO association pattern periods, regardless of number of multiple PRACH transmissions that is configured by the network.

In another embodiment, association pattern period for multiple PRACH transmissions is determined as K SSB to RO association pattern periods, where K may be determined which depends on whether separate preambles on shared PRACH occasions or separate PRACH occasions are used for the differentiation of different number of multiple PRACH transmissions.

In one example, in case of separate ROs for differentiation of different number of multiple PRACH transmissions, K is determined as the number of multiple PRACH transmissions, where different K values are determined for different number of multiple PRACH transmissions. Further, in case of separate preambles on shared ROs for differentiation of different number of multiple PRACH transmissions, K is determined as smallest or largest value among the number of multiple PRACH transmissions that is configured by the network.

### PRACH Mask for Multiple PRACH Transmissions

Various embodiments provide a PRACH mask for multiple PRACH transmissions.

In one embodiment, for physical downlink control channel (PDCCH) ordered multiple PRACH transmissions, the PRACH mask index is used to indicate the RACH occasion group associated with the SS/PBCH indicated by “SS/PBCH index” for the multiple PRACH transmissions.

The following text in Clause 7.3.1.2.1 in TS38.212 “NR: Multiplexing and channel coding” can be updated as shown below in italics in accordance with various embodiments.
PRACH Mask index-4 bits. If the value of number of multiple PRACH transmissions is equal to 1, if the value of the “Random Access Preamble index” is not all zeros, this field indicates the RACH occasion associated with the SS/PBCH indicated by “SS/PBCH index” for the PRACH transmission, according to Clause 5.1.1 of [8, TS38.321]; otherwise, this field is reserved.

If the value of number of multiple PRACH transmissions is larger than 1, if the value of the “Random Access Preamble index” is not all zeros, this field indicates the RACH occasion group associated with the SS/PBCH indicated by “SS/PBCH index” for the multiple PRACH transmissions, according to Clause 5.1.1 of [8, TS38.321]; otherwise, this field is reserved.

In one option, for multiple PRACH transmissions, the PRACH mask index value may be updated to indicate that the PRACH occasion group associated with indicated SSB index is used for multiple PRACH transmissions. Table 1 illustrates one example of PRACH mask index value for PRACH occasion group for multiple PRACH transmissions. Note that the Table can be included in Clause 7.4 in TS38.321 “NR: Medium Access Control (MAC) protocol specification.”

TABLE 1
PRACH mask index value (Option 1)

| PRACH Mask Index | Allowed PRACH occasion group(s) of SSB |
|---|---|
| 0 | All |
| 1 | PRACH occasion group index 1 |
| 2 | PRACH occasion group index 2 |
| 3 | PRACH occasion group index 3 |
| 4 | PRACH occasion group index 4 |
| 5 | PRACH occasion group index 5 |
| 6 | PRACH occasion group index 6 |
| 7 | PRACH occasion group index 7 |
| 8 | PRACH occasion group index 8 |
| 9 | Every even PRACH group occasion |
| 10 | Every odd PRACH group occasion |
| 11 | Reserved |
| 12 | Reserved |
| 13 | Reserved |
| 14 | Reserved |
| 15 | Reserved |

In another option, the reserved fields in the Table of PRACH mask index value may be updated to include the PRACH occasion group index associated with the indicated SSB index for multiple PRACH transmissions.

Table 2 illustrates one example of PRACH mask index value for PRACH occasion group for multiple PRACH transmissions. In the table, the text with red color in Clause 7.4 in TS38.321 [2] is used to indicate the PRACH occasion group associated with indicated SSB index is used for multiple PRACH transmissions. In case of multiple PRACH transmissions, PRACH mask index field with value of 11, 12, 13 and 14 can be used.

TABLE 2
PRACH mask index value (Option 2)

| PRACH Mask Index | Allowed PRACH occasion(s) of SSB |
|---|---|
| 0 | All |
| 1 | PRACH occasion index 1 |
| 2 | PRACH occasion index 2 |
| 3 | PRACH occasion index 3 |
| 4 | PRACH occasion index 4 |
| 5 | PRACH occasion index 5 |
| 6 | PRACH occasion index 6 |
| 7 | PRACH occasion index 7 |
| 8 | PRACH occasion index 8 |
| 9 | Every even PRACH occasion |
| 10 | Every odd PRACH occasion |
| 11 | PRACH occasion group index 1 |
| 12 | PRACH occasion group index 2 |
| 13 | PRACH occasion group index 3 |
| 14 | PRACH occasion group index 4 |
| 15 | Reserved |

In another embodiment, in case separate preambles on shared ROs are configured to differentiate single and multiple PRACH transmissions, PRACH mask index may be configured to indicate that a subset of PRACH occasions that are configured for single PRACH transmission may be used for multiple PRACH transmissions.

In one example, if PRACH mask index with value 9 is configured, every even PRACH occasion associated with an SSB that is configured for single PRACH transmission can be used for multiple PRACH transmissions.

In one option, same PRACH mask index may be configured for multiple PRACH transmissions with different number of repetitions.

In another option, different PRACH mask index may be configured for multiple PRACH transmissions with different number of repetitions.

In another embodiment, in case separate preambles on shared ROs are configured to differentiate multiple PRACH transmissions with different number of repetitions, PRACH mask index may be configured to indicate that a subset of PRACH occasion may be used for multiple PRACH transmissions.

In one example, if 2 and 4 repetitions are configured for multiple PRACH transmissions, if PRACH mask index with value 9 is configured, every even PRACH occasion associated with an SSB that are configured for 2 repetitions can be used for multiple PRACH transmissions with 4 repetitions.

In one option, same PRACH mask index may be configured for multiple PRACH transmissions with different number of repetitions.

In another option, different PRACH mask index may be configured for multiple PRACH transmissions with different number of repetitions.

### Systems and Implementations

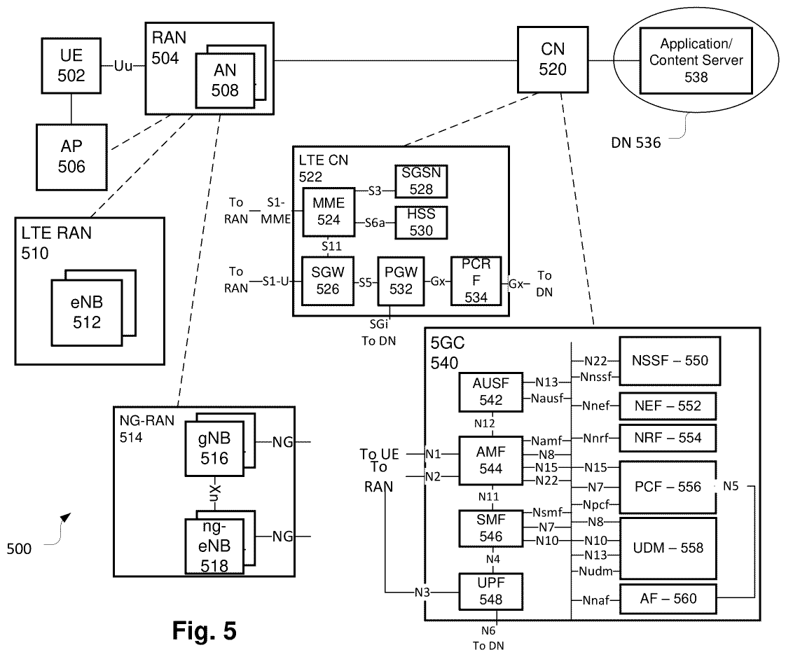

FIGS. 5-8 illustrate various systems, devices, and components that may implement aspects of disclosed embodiments.

FIG. 5 illustrates a network 500 in accordance with various embodiments. The network 500 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 500 may include a UE 502, which may include any mobile or non-mobile computing device designed to communicate with a RAN 504 via an over-the-air connection. The UE 502 may be communicatively coupled with the RAN 504 by a Uu interface. The UE 502 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 500 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 502 may additionally communicate with an AP 506 via an over-the-air connection. The AP 506 may manage a WLAN connection, which may serve to offload some/all network traffic from the RAN 504. The connection between the UE 502 and the AP 506 may be consistent with any IEEE 702.11 protocol, wherein the AP 506 could be a wireless fidelity (Wi-Fi®) router. In some embodiments, the UE 502, RAN 504, and AP 506 may utilize cellular-WLAN aggregation (for example, LWA/LWIP). Cellular-WLAN aggregation may involve the UE 502 being configured by the RAN 504 to utilize both cellular radio resources and WLAN resources.

The RAN 504 may include one or more access nodes, for example, AN 508. AN 508 may terminate air-interface protocols for the UE 502 by providing access stratum protocols including RRC, PDCP, RLC, MAC, and L1 protocols. In this manner, the AN 508 may enable data/voice connectivity between CN 520 and the UE 502. In some embodiments, the AN 508 may be implemented in a discrete device or as one or more software entities running on server computers as part of, for example, a virtual network, which may be referred to as a CRAN or virtual baseband unit pool. The AN 508 be referred to as a BS, gNB, RAN node, eNB, ng-eNB, NodeB, RSU, TRxP, TRP, etc. The AN 508 may be a macrocell base station or a low power base station for providing femtocells, picocells or other like cells having smaller coverage areas, smaller user capacity, or higher bandwidth compared to macrocells.

In embodiments in which the RAN 504 includes a plurality of ANs, they may be coupled with one another via an X2 interface (if the RAN 504 is an LTE RAN) or an Xn interface (if the RAN 504 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 504 may each manage one or more cells, cell groups, component carriers, etc. to provide the UE 502 with an air interface for network access. The UE 502 may be simultaneously connected with a plurality of cells provided by the same or different ANs of the RAN 504. For example, the UE 502 and RAN 504 may use carrier aggregation to allow the UE 502 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 504 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 502 or AN 508 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU;” an eNB may be referred to as an “eNB-type RSU;” a gNB may be referred to as a “gNB-type RSU;” and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 504 may be an LTE RAN 510 with eNBs, for example, eNB 512. The LTE RAN 510 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 504 may be an NG-RAN 514 with gNBs, for example, gNB 516, or ng-eNBs, for example, ng-eNB 518. The gNB 516 may connect with 5G-enabled UEs using a 5G NR interface. The gNB 516 may connect with a 5G core through an NG interface, which may include an N2 interface or an N3 interface. The ng-eNB 518 may also connect with the 5G core through an NG interface, but may connect with a UE via an LTE air interface. The gNB 516 and the ng-eNB 518 may connect with each other over an Xn interface.

In some embodiments, the NG interface may be split into two parts, an NG user plane (NG-U) interface, which carries traffic data between the nodes of the NG-RAN 514 and a UPF 548 (e.g., N3 interface), and an NG control plane (NG-C) interface, which is a signaling interface between the nodes of the NG-RAN514 and an AMF 544 (e.g., N2 interface).

The NG-RAN 514 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operate on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 502 can be configured with multiple BWPs where each BWP configuration has a different SCS. When a BWP change is indicated to the UE 502, the SCS of the transmission is changed as well. Another use case example of BWP is related to power saving. In particular, multiple BWPs can be configured for the UE 502 with different amount of frequency resources (for example, PRBs) to support data transmission under different traffic loading scenarios. A BWP containing a smaller number of PRBs can be used for data transmission with small traffic load while allowing power saving at the UE 502 and in some cases at the gNB 516. A BWP containing a larger number of PRBs can be used for scenarios with higher traffic load.

The RAN 504 is communicatively coupled to CN 520 that includes network elements to provide various functions to support data and telecommunications services to customers/subscribers (for example, users of UE 502). The components of the CN 520 may be implemented in one physical node or separate physical nodes. In some embodiments, NFV may be utilized to virtualize any or all of the functions provided by the network elements of the CN 520 onto physical compute/storage resources in servers, switches, etc. A logical instantiation of the CN 520 may be referred to as a network slice, and a logical instantiation of a portion of the CN 520 may be referred to as a network sub-slice.

In some embodiments, the CN 520 may be an LTE CN 522, which may also be referred to as an EPC. The LTE CN 522 may include MME 524, SGW 526, SGSN 528, HSS 530, PGW 532, and PCRF 534 coupled with one another over interfaces (or “reference points”) as shown. Functions of the elements of the LTE CN 522 may be briefly introduced as follows.

The MME 524 may implement mobility management functions to track a current location of the UE 502 to facilitate paging, bearer activation/deactivation, handovers, gateway selection, authentication, etc.

The SGW 526 may terminate an S1 interface toward the RAN and route data packets between the RAN and the LTE CN 522. The SGW 526 may be a local mobility anchor point for inter-RAN node handovers and also may provide an anchor for inter-3GPP mobility. Other responsibilities may include lawful intercept, charging, and some policy enforcement.

The SGSN 528 may track a location of the UE 502 and perform security functions and access control. In addition, the SGSN 528 may perform inter-EPC node signaling for mobility between different RAT networks; PDN and S-GW selection as specified by MME 524; MME selection for handovers; etc. The S3 reference point between the MME 524 and the SGSN 528 may enable user and bearer information exchange for inter-3GPP access network mobility in idle/active states.

The HSS 530 may include a database for network users, including subscription-related information to support the network entities' handling of communication sessions. The HSS 530 can provide support for routing/roaming, authentication, authorization, naming/addressing resolution, location dependencies, etc. An S6a reference point between the HSS 530 and the MME 524 may enable transfer of subscription and authentication data for authenticating/authorizing user access to the LTE CN 520.

The PGW 532 may terminate an SGi interface toward a data network (DN) 536 that may include an application/content server 538. The PGW 532 may route data packets between the LTE CN 522 and the data network 536. The PGW 532 may be coupled with the SGW 526 by an S5 reference point to facilitate user plane tunneling and tunnel management. The PGW 532 may further include a node for policy enforcement and charging data collection (for example, PCEF). Additionally, the SGi reference point between the PGW 532 and the data network YX 36 may be an operator external public, a private PDN, or an intra-operator packet data network, for example, for provision of IMS services. The PGW 532 may be coupled with a PCRF 534 via a Gx reference point.

The PCRF 534 is the policy and charging control element of the LTE CN 522. The PCRF 534 may be communicatively coupled to the app/content server 538 to determine appropriate QoS and charging parameters for service flows. The PCRF 532 may provision associated rules into a PCEF (via Gx reference point) with appropriate TFT and QCI.

In some embodiments, the CN 520 may be a 5GC 540. The 5GC 540 may include an AUSF 542, AMF 544, SMF 546, UPF 548, NSSF 550, NEF 552, NRF 554, PCF 556, UDM 558, and AF 560 coupled with one another over interfaces (or “reference points”) as shown. Functions of the elements of the 5GC 540 may be briefly introduced as follows.

The AUSF 542 may store data for authentication of UE 502 and handle authentication-related functionality. The AUSF 542 may facilitate a common authentication framework for various access types. In addition to communicating with other elements of the 5GC 540 over reference points as shown, the AUSF 542 may exhibit an Nausf service-based interface.

The AMF 544 may allow other functions of the 5GC 540 to communicate with the UE 502 and the RAN 504 and to subscribe to notifications about mobility events with respect to the UE 502. The AMF 544 may be responsible for registration management (for example, for registering UE 502), connection management, reachability management, mobility management, lawful interception of AMF-related events, and access authentication and authorization. The AMF 544 may provide transport for SM messages between the UE 502 and the SMF 546, and act as a transparent proxy for routing SM messages. AMF 544 may also provide transport for SMS messages between UE 502 and an SMSF. AMF 544 may interact with the AUSF 542 and the UE 502 to perform various security anchor and context management functions. Furthermore, AMF 544 may be a termination point of a RAN CP interface, which may include or be an N2 reference point between the RAN 504 and the AMF 544; and the AMF 544 may be a termination point of NAS (N1) signaling, and perform NAS ciphering and integrity protection. AMF 544 may also support NAS signaling with the UE 502 over an N3 IWF interface.

The SMF 546 may be responsible for SM (for example, session establishment, tunnel management between UPF 548 and AN 508); UE IP address allocation and management (including optional authorization); selection and control of UP function; configuring traffic steering at UPF 548 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 544 over N2 to AN 508; and determining SSC mode of a session. SM may refer to management of a PDU session, and a PDU session or “session” may refer to a PDU connectivity service that provides or enables the exchange of PDUs between the UE 502 and the data network 536.

The UPF 548 may act as an anchor point for intra-RAT and inter-RAT mobility, an external PDU session point of interconnect to data network 536, and a branching point to support multi-homed PDU session. The UPF 548 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 548 may include an uplink classifier to support routing traffic flows to a data network.

The NSSF 550 may select a set of network slice instances serving the UE 502. The NSSF 550 may also determine allowed NSSAI and the mapping to the subscribed S-NSSAIs, if needed. The NSSF 550 may also determine the AMF set to be used to serve the UE 502, or a list of candidate AMFs based on a suitable configuration and possibly by querying the NRF 554. The selection of a set of network slice instances for the UE 502 may be triggered by the AMF 544 with which the UE 502 is registered by interacting with the NSSF 550, which may lead to a change of AMF. The NSSF 550 may interact with the AMF 544 via an N22 reference point; and may communicate with another NSSF in a visited network via an N31 reference point (not shown). Additionally, the NSSF 550 may exhibit an Nnssf service-based interface.

The NEF 552 may securely expose services and capabilities provided by 3GPP network functions for third party, internal exposure/re-exposure, AFs (e.g., AF 560), edge computing or fog computing systems, etc. In such embodiments, the NEF 552 may authenticate, authorize, or throttle the AFs. NEF 552 may also translate information exchanged with the AF 560 and information exchanged with internal network functions. For example, the NEF 552 may translate between an AF-Service-Identifier and an internal 5GC information. NEF 552 may also receive information from other NFs based on exposed capabilities of other NFs. This information may be stored at the NEF 552 as structured data, or at a data storage NF using standardized interfaces. The stored information can then be re-exposed by the NEF 552 to other NFs and AFs, or used for other purposes such as analytics. Additionally, the NEF 552 may exhibit an Nnef service-based interface.

The NRF 554 may support service discovery functions, receive NF discovery requests from NF instances, and provide the information of the discovered NF instances to the NF instances. NRF 554 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 554 may exhibit the Nnrf service-based interface.

The PCF 556 may provide policy rules to control plane functions to enforce them, and may also support unified policy framework to govern network behavior. The PCF 556 may also implement a front end to access subscription information relevant for policy decisions in a UDR of the UDM 558. In addition to communicating with functions over reference points as shown, the PCF 556 exhibit an Npcf service-based interface.

The UDM 558 may handle subscription-related information to support the network entities' handling of communication sessions, and may store subscription data of UE 502. For example, subscription data may be communicated via an N8 reference point between the UDM 558 and the AMF 544. The UDM 558 may include two parts, an application front end and a UDR. The UDR may store subscription data and policy data for the UDM 558 and the PCF 556, and/or structured data for exposure and application data (including PFDs for application detection, application request information for multiple UEs 502) for the NEF 552. The Nudr service-based interface may be exhibited by the UDR 221 to allow the UDM 558, PCF 556, and NEF 552 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 558 may exhibit the Nudm service-based interface.

The AF 560 may provide application influence on traffic routing, provide access to NEF, and interact with the policy framework for policy control.

In some embodiments, the 5GC 540 may enable edge computing by selecting operator/3rd party services to be geographically close to a point that the UE 502 is attached to the network. This may reduce latency and load on the network. To provide edge-computing implementations, the 5GC 540 may select a UPF 548 close to the UE 502 and execute traffic steering from the UPF 548 to data network 536 via the N6 interface. This may be based on the UE subscription data, UE location, and information provided by the AF 560. In this way, the AF 560 may influence UPF (re) selection and traffic routing. Based on operator deployment, when AF 560 is considered to be a trusted entity, the network operator may permit AF 560 to interact directly with relevant NFs. Additionally, the AF 560 may exhibit an Naf service-based interface.

The data network 536 may represent various network operator services, Internet access, or third party services that may be provided by one or more servers including, for example, application/content server 538.

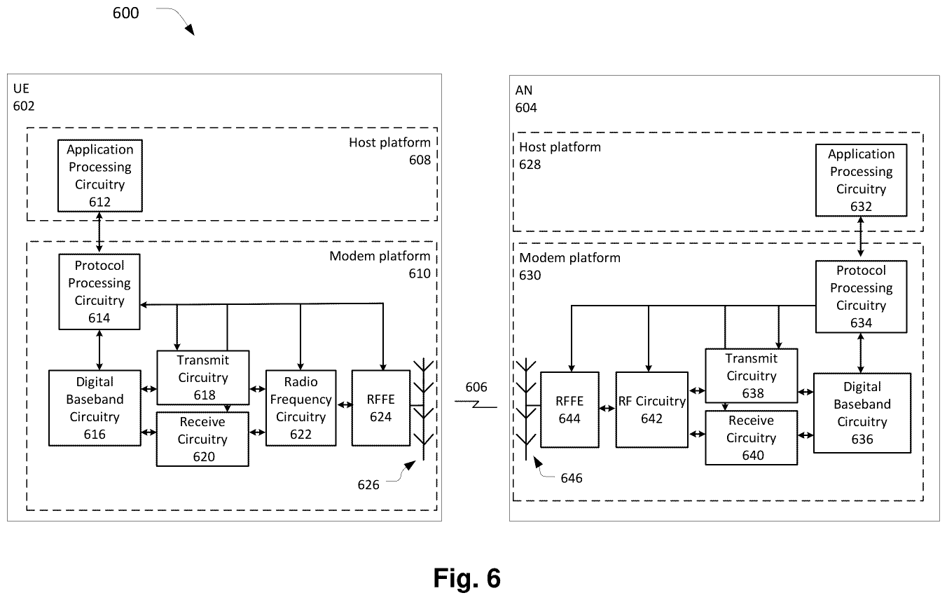

FIG. 6 schematically illustrates a wireless network 600 in accordance with various embodiments. The wireless network 600 may include a UE 602 in wireless communication with an AN 604. The UE 602 and AN 604 may be similar to, and substantially interchangeable with, like-named components described elsewhere herein.

The UE 602 may be communicatively coupled with the AN 604 via connection 606. The connection 606 is illustrated as an air interface to enable communicative coupling, and can be consistent with cellular communications protocols such as an LTE protocol or a 5G NR protocol operating at mmWave or sub-6 GHZ frequencies.

The UE 602 may include a host platform 608 coupled with a modem platform 610. The host platform 608 may include application processing circuitry 612, which may be coupled with protocol processing circuitry 614 of the modem platform 610. The application processing circuitry 612 may run various applications for the UE 602 that source/sink application data. The application processing circuitry 612 may further implement one or more layer operations to transmit/receive application data to/from a data network. These layer operations may include transport (for example UDP) and Internet (for example, IP) operations

The protocol processing circuitry 614 may implement one or more of layer operations to facilitate transmission or reception of data over the connection 606. The layer operations implemented by the protocol processing circuitry 614 may include, for example, MAC, RLC, PDCP, RRC and NAS operations.

The modem platform 610 may further include digital baseband circuitry 616 that may implement one or more layer operations that are “below” layer operations performed by the protocol processing circuitry 614 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 610 may further include transmit circuitry 618, receive circuitry 620, RF circuitry 622, and RF front end (RFFE) 624, which may include or connect to one or more antenna panels 626. Briefly, the transmit circuitry 618 may include a digital-to-analog converter, mixer, intermediate frequency (IF) components, etc.; the receive circuitry 620 may include an analog-to-digital converter, mixer, IF components, etc.; the RF circuitry 622 may include a low-noise amplifier, a power amplifier, power tracking components, etc.; RFFE 624 may include filters (for example, surface/bulk acoustic wave filters), switches, antenna tuners, beamforming components (for example, phase-array antenna components), etc. The selection and arrangement of the components of the transmit circuitry 618, receive circuitry 620, RF circuitry 622, RFFE 624, and antenna panels 626 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 614 may include one or more instances of control circuitry (not shown) to provide control functions for the transmit/receive components.

A UE reception may be established by and via the antenna panels 626, RFFE 624, RF circuitry 622, receive circuitry 620, digital baseband circuitry 616, and protocol processing circuitry 614. In some embodiments, the antenna panels 626 may receive a transmission from the AN 604 by receive-beamforming signals received by a plurality of antennas/antenna elements of the one or more antenna panels 626.

A UE transmission may be established by and via the protocol processing circuitry 614, digital baseband circuitry 616, transmit circuitry 618, RF circuitry 622, RFFE 624, and antenna panels 626. In some embodiments, the transmit components of the UE 604 may apply a spatial filter to the data to be transmitted to form a transmit beam emitted by the antenna elements of the antenna panels 626.

Similar to the UE 602, the AN 604 may include a host platform 628 coupled with a modem platform 630. The host platform 628 may include application processing circuitry 632 coupled with protocol processing circuitry 634 of the modem platform 630. The modem platform may further include digital baseband circuitry 636, transmit circuitry 638, receive circuitry 640, RF circuitry 642, RFFE circuitry 644, and antenna panels 646. The components of the AN 604 may be similar to and substantially interchangeable with like-named components of the UE 602. In addition to performing data transmission/reception as described above, the components of the AN 608 may perform various logical functions that include, for example, RNC functions such as radio bearer management, uplink and downlink dynamic radio resource management, and data packet scheduling.

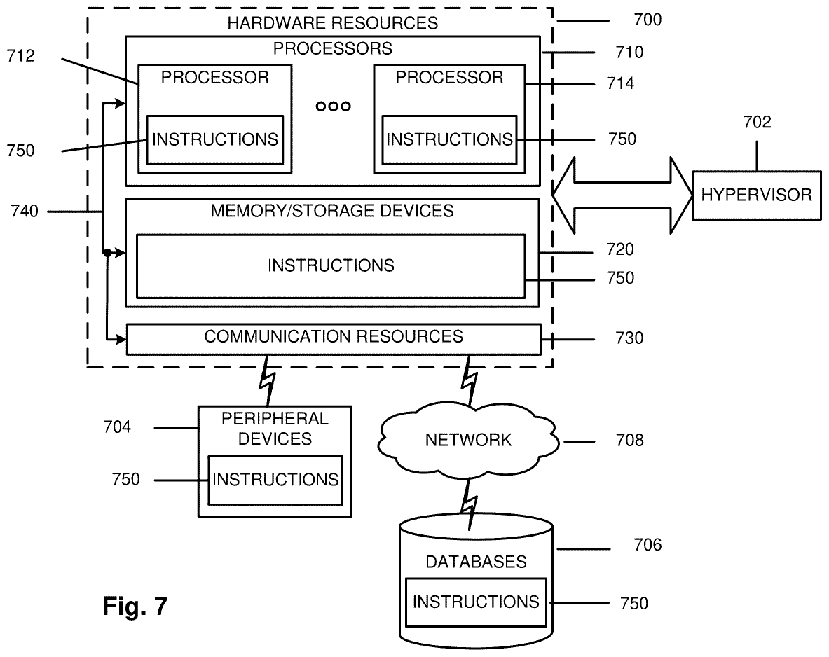

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740 or other interface circuitry. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714. The processors 710 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 720 may include main memory, disk storage, or any suitable combination thereof. The memory/storage devices 720 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 730 may include interconnection or network interface controllers, components, or other suitable devices to communicate with one or more peripheral devices 704 or one or more databases 706 or other network elements via a network 708. For example, the communication resources 730 may include wired communication components (e.g., for coupling via USB, Ethernet, etc.), cellular communication components, NFC components, Bluetooth® (or Bluetooth® Low Energy) components, Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

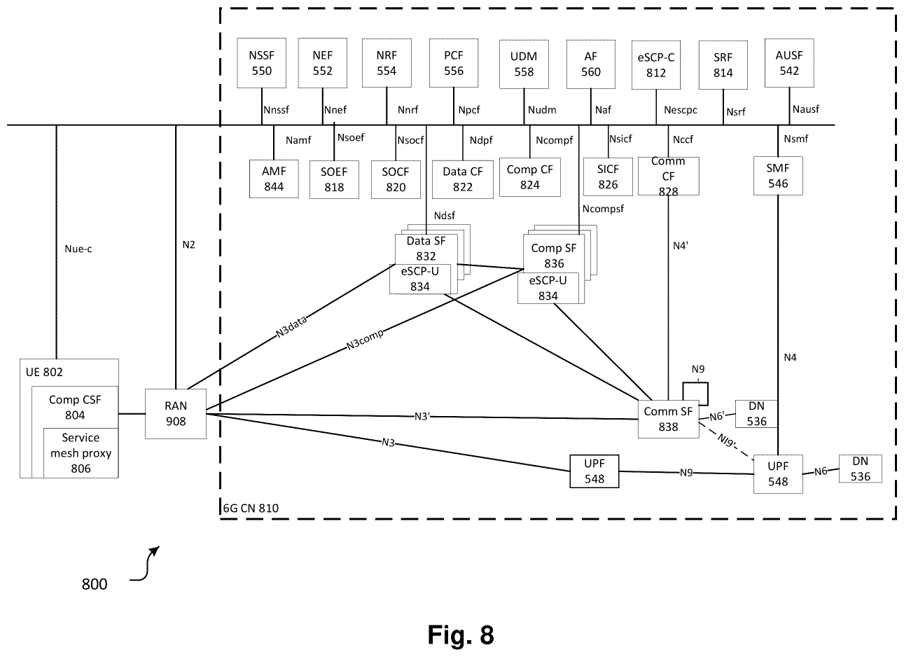

FIG. 8 illustrates a network 800 in accordance with various embodiments. The network 800 may operate in a matter consistent with 3GPP technical specifications or technical reports for 6G systems. In some embodiments, the network 800 may operate concurrently with network 500. For example, in some embodiments, the network 800 may share one or more frequency or bandwidth resources with network 500. As one specific example, a UE (e.g., UE 802) may be configured to operate in both network 800 and network 500. Such configuration may be based on a UE including circuitry configured for communication with frequency and bandwidth resources of both networks 500 and 800. In general, several elements of network 800 may share one or more characteristics with elements of network 500. For the sake of brevity and clarity, such elements may not be repeated in the description of network 800.

The network 800 may include a UE 802, which may include any mobile or non-mobile computing device designed to communicate with a RAN 808 via an over-the-air connection. The UE 802 may be similar to, for example, UE 502. The UE 802 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 8, in some embodiments the network 800 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 8, the UE 802 may be communicatively coupled with an AP such as AP 506 as described with respect to FIG. 5. Additionally, although not specifically shown in FIG. 8, in some embodiments the RAN 808 may include one or more ANss such as AN 508 as described with respect to FIG. 5. The RAN 808 and/or the AN of the RAN 808 may be referred to as a base station (BS), a RAN node, or using some other term or name.

The UE 802 and the RAN 808 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 808 may allow for communication between the UE 802 and a 6G core network (CN) 810. Specifically, the RAN 808 may facilitate the transmission and reception of data between the UE 802 and the 6G CN 810. The 6G CN 810 may include various functions such as NSSF 550, NEF 552, NRF 554, PCF 556, UDM 558, AF 560, SMF 546, and AUSF 542. The 6G CN 810 may additional include UPF 548 and DN 536 as shown in FIG. 8.

Additionally, the RAN 808 may include various additional functions that are in addition to, or alternative to, functions of a legacy cellular network such as a 4G or 5G network. Two such functions may include a Compute Control Function (Comp CF) 824 and a Compute Service Function (Comp SF) 836. The Comp CF 824 and the Comp SF 836 may be parts or functions of the Computing Service Plane. Comp CF 824 may be a control plane function that provides functionalities such as management of the Comp SF 836, computing task context generation and management (e.g., create, read, modify, delete), interaction with the underlying computing infrastructure for computing resource management, etc. . . . Comp SF 836 may be a user plane function that serves as the gateway to interface computing service users (such as UE 802) and computing nodes behind a Comp SF instance. Some functionalities of the Comp SF 836 may include: parse computing service data received from users to compute tasks executable by computing nodes; hold service mesh ingress gateway or service API gateway; service and charging policies enforcement; performance monitoring and telemetry collection, etc. In some embodiments, a Comp SF 836 instance may serve as the user plane gateway for a cluster of computing nodes. A Comp CF 824 instance may control one or more Comp SF 836 instances.

Two other such functions may include a Communication Control Function (Comm CF) 828 and a Communication Service Function (Comm SF) 838, which may be parts of the Communication Service Plane. The Comm CF 828 may be the control plane function for managing the Comm SF 838, communication sessions creation/configuration/releasing, and managing communication session context. The Comm SF 838 may be a user plane function for data transport. Comm CF 828 and Comm SF 838 may be considered as upgrades of SMF 546 and UPF 548, which were described with respect to a 5G system in FIG. 5. The upgrades provided by the Comm CF 828 and the Comm SF 838 may enable service-aware transport. For legacy (e.g., 4G or 5G) data transport, SMF 546 and UPF 548 may still be used.

Two other such functions may include a Data Control Function (Data CF) 822 and Data Service Function (Data SF) 832 may be parts of the Data Service Plane. Data CF 822 may be a control plane function and provides functionalities such as Data SF 832 management, Data service creation/configuration/releasing, Data service context management, etc. Data SF 832 may be a user plane function and serve as the gateway between data service users (such as UE 802 and the various functions of the 6G CN 810) and data service endpoints behind the gateway. Specific functionalities may include: parse data service user data and forward to corresponding data service endpoints, generate charging data, report data service status.

Another such function may be the Service Orchestration and Chaining Function (SOCF) 820, which may discover, orchestrate and chain up communication/computing/data services provided by functions in the network. Upon receiving service requests from users, SOCF 820 may interact with one or more of Comp CF 824, Comm CF 828, and Data CF 822 to identify Comp SF 836, Comm SF 838, and Data SF 832 instances, configure service resources, and generate the service chain, which could contain multiple Comp SF 836, Comm SF 838, and Data SF 832 instances and their associated computing endpoints. Workload processing and data movement may then be conducted within the generated service chain. The SOCF 820 may also responsible for maintaining, updating, and releasing a created service chain.

Another such function may be the service registration function (SRF) 814, which may act as a registry for system services provided in the user plane such as services provided by service endpoints behind Comp SF 836 and Data SF 832 gateways and services provided by the UE 802. The SRF 814 may be considered a counterpart of NRF 554, which may act as the registry for network functions.

Other such functions may include an evolved service communication proxy (eSCP) and service infrastructure control function (SICF) 826, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 812 and eSCP-U 834, for control plane service communication proxy and user plane service communication proxy, respectively. The SICF 826 may control and configure eCSP instances in terms of service traffic routing policies, access rules, load balancing configurations, performance monitoring, etc.

Another such function is the AMF 844. The AMF 844 may be similar to 544, but with additional functionality. Specifically, the AMF 844 may include potential functional repartition, such as move the message forwarding functionality from the AMF 844 to the RAN 808.

Another such function is the service orchestration exposure function (SOEF) 818. The SOEF may be configured to expose service orchestration and chaining services to external users such as applications.

The UE 802 may include an additional function that is referred to as a computing client service function (comp CSF) 804. The comp CSF 804 may have both the control plane functionalities and user plane functionalities, and may interact with corresponding network side functions such as SOCF 820, Comp CF 824, Comp SF 836, Data CF 822, and/or Data SF 832 for service discovery, request/response, compute task workload exchange, etc. The Comp CSF 804 may also work with network side functions to decide on whether a computing task should be run on the UE 802, the RAN 808, and/or an element of the 6G CN 810.

The UE 802 and/or the Comp CSF 804 may include a service mesh proxy 806. The service mesh proxy 806 may act as a proxy for service-to-service communication in the user plane. Capabilities of the service mesh proxy 806 may include one or more of addressing, security, load balancing, etc.

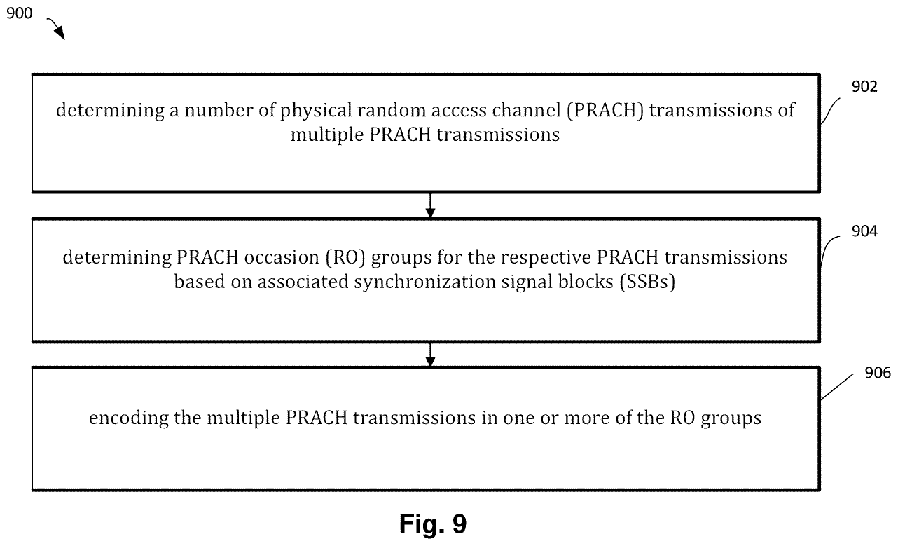

In some embodiments, for example as depicted in FIG. 9, the electronic device(s), network(s), system(s), chip(s) or component(s), or portions or implementations thereof, of FIGS. 5-8, or some other figure herein, may be configured to perform one or more processes, techniques, or methods as described herein, or portions thereof. For example, the process may include, at 902, determining a number of physical random access channel (PRACH) transmissions of multiple PRACH transmissions. At 904, the process may further include determining PRACH occasion (RO) groups for the respective PRACH transmissions based on associated synchronization signal blocks (SSBs). At 906, the process may further include encoding the multiple PRACH transmissions in one or more of the RO groups.

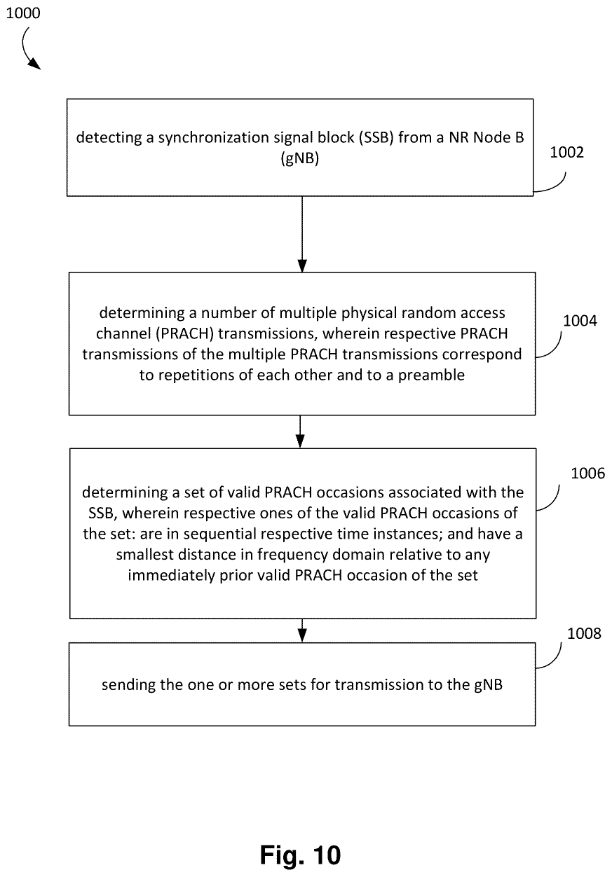

FIG. 10 illustrates a method 1000 according to a first embodiment. Method 1000 includes, at operation 1002, detecting a synchronization signal block (SSB) from a NR Node B (gNB); at operation 1004, determining a number of multiple physical random access channel (PRACH) transmissions, wherein respective PRACH transmissions of the multiple PRACH transmissions correspond to repetitions of each other and to a preamble; at operation 1006, determining a set of valid PRACH occasions associated with the SSB, wherein respective ones of the valid PRACH occasions of the set: are in sequential respective time instances; and use same frequency resources as any immediately prior PRACH occasion of the set; and at operation 1008, sending the one or more sets for transmission to the gNB.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 includes an apparatus of a New Radio (NR) User Equipment (UE), the apparatus including a processing circuitry and a radio frequency (RF) circuitry interface to couple the processing circuitry to an RF circuitry of the UE, the processing circuitry to: detect a synchronization signal block (SSB) from a NR Node B (gNB); determine a number of multiple physical random access channel (PRACH) transmissions, wherein respective PRACH transmissions of the multiple PRACH transmissions correspond to repetitions of each other and to a preamble; determine a set of valid PRACH occasions associated with the SSB, wherein respective ones of the valid PRACH occasions of the set: are in sequential respective time instances; and use same frequency resources as any immediately prior PRACH occasion of the set; and send the multiple PRACH transmissions in the set for transmission to the gNB.

Example 2 includes the subject matter of Example 1, wherein the sequential respective time instances correspond to consecutive respective time instances.

Example 3 includes the subject matter of Example 1, wherein, starting at frame 0 of a time period, a first valid PRACH occasion corresponds to a first valid PRACH occasion of the set.

Example 4 includes the subject matter of Example 1, wherein the set is a first set, the processing circuitry to further determine a plurality of sets of valid PRACH occasions associated with the SSB, the plurality of sets including the first set.

Example 5 includes the subject matter of Example 4, where the SSB is a first SSB, the plurality of sets of valid PRACH occasions is a first plurality of sets of valid PRACH occasions, the processing circuitry to: detect a plurality of SSBs including the first SSB; and determine pluralities of sets of valid PRACH occasions including the first plurality of sets of valid PRACH occasions, respective ones of the pluralities of sets of valid PRACH occasions corresponding to a respective one of the plurality of SSBs.

Example 6 includes the subject matter of any one of Examples 1-5, wherein a number of the repetitions includes one of 2 or 4.

Example 7 includes the subject matter of any one of Examples 1-5, the processing circuitry to determine the set associated with the SSB within an SSB to PRACH occasion set association pattern period.

Example 8 includes the subject matter of any one of Examples 1-5 the processing circuitry to determine the set associated with the SSB within an SSB to PRACH occasion set association pattern period.

Example 9 includes the subject matter of Example 8, further including a memory interface to send or receive data from a memory of the UE.

Example 10 includes the subject matter of Example 9, further including a radio frequency (RF) circuitry coupled to the processing circuitry.

Example 11 includes the subject matter of Example 10, further including a front end coupled to the RF circuitry.

Example 12 includes the subject matter of Example 11, further including one or more antenna elements coupled to the front end, the one or more antenna elements to communicate wireless signals from and to the UE.

Example 13 includes a method to be performed at Example X includes an apparatus of a New Radio (NR) User Equipment (UE), the method including: detecting a synchronization signal block (SSB) from a NR Node B (gNB); determine a number of multiple physical random access channel (PRACH) transmissions, wherein respective PRACH transmissions of the multiple PRACH transmissions correspond to repetitions of each other and to a preamble; determine a set of valid PRACH occasions associated with the SSB, wherein respective ones of the valid PRACH occasions of the set: are in sequential respective time instances; and use same frequency resources as any immediately prior PRACH occasion of the set; and send the multiple PRACH transmissions in the set for transmission to the gNB.

Example 14 includes the subject matter of Example 13, wherein the sequential respective time instances correspond to consecutive respective time instances.

Example 15 includes the subject matter of Example 13, wherein, starting at frame 0 of a time period, a first valid PRACH occasion corresponds to a first valid PRACH occasion of the set.

Example 16 includes the subject matter of Example 13, wherein the set is a first set, further including determining a plurality of sets of valid PRACH occasions associated with the SSB, the plurality of sets including the first set.

Example 17 includes the subject matter of Example 16, where the SSB is a first SSB, the plurality of sets of valid PRACH occasions is a first plurality of sets of valid PRACH occasions, further including: detecting a plurality of SSBs including the first SSB; and determining pluralities of sets of valid PRACH occasions including the first plurality of sets of valid PRACH occasions, respective ones of the pluralities of sets of valid PRACH occasions corresponding to a respective one of the plurality of SSBs.

Example 18 includes the subject matter of Example 13, wherein a number of the repetitions includes one of 2 or 4.

Example 19 includes the subject matter of Example 13, further including determining the set associated with the SSB within an SSB to PRACH occasion set association pattern period.

Example 20 includes the subject matter of Example 13, further including sending data to or receiving data from a memory of the UE.

Example 21 includes the subject matter of Example 13, wherein sending for transmission includes sending to a radio frequency (RF) circuitry of the UE.

Example 22 includes the subject matter of Example 21, wherein sending for transmission further includes sending to a front end coupled to the RF circuitry.

Example 23 includes the subject matter of Example 22, wherein sending for transmission further includes sending to one or more antenna elements coupled to the front end.

Example 24 includes a machine readable medium including code which, when executed, is to cause a machine to perform the method of any one of Examples 13-23.

Example 25 includes an apparatus including means to perform Example X includes the subject matter of any one of Examples 13-23.

Example A1 may include a method of wireless communication (e.g., for a fifth generation (5G) or new radio (NR) system), the method comprising: receiving, by a UE from a gNB, a configuration of one or more number of multiple physical random access channel (PRACH) transmissions, determining, by the UE, the number of multiple PRACH transmissions; and determining, by the UE, a set of PRACH occasions for multiple PRACH transmissions in accordance with the determined number of multiple PRACH transmissions.

Example A2 may include the method of Example A1 or some other Example herein, wherein for Step 1: if only one valid RO is associated with an SSB in a time instance, the RO is determined as a first RO in a first RO group; if more than one valid ROs associated with an SSB are multiplexed in a frequency division multiplexing (FDM) manner, the RO with smallest or largest index is determined as a first RO in a first RO group.

Example A3 may include the method of Example A1 or some other Example herein, wherein for Step 1: if next available valid RO is associated with the same SSB and in a different time instances from the first RO, and if there is no other ROs that are multiplexed in a FDM manner with the next available valid RO, the next available valid RO is determined as a second RO in the first RO group.

Example A4 may include the method of Example A1 or some other Example herein, wherein if more than one ROs that are associated with the same SSB and in a different time instances from the first RO are multiplexed in a FDM manner; the valid RO with the smallest RO index is determined as a second RO in the first RO group.

Example A5 may include the method of Example A1 or some other Example herein, wherein the valid RO with closest distance in frequency domain with the first RO is determined as a second RO in the first RO group, where the closest distance in frequency domain may be interpreted as the RO index in frequency domain.

Example A6 may include the method of Example A1 or some other Example herein, wherein for Step 3: the procedure in Step 1 and Step 2 is continued to determine the all the ROs in the first RO group associated with the SSB, until the number of determined valid ROs is equal to the number of repetitions for multiple PRACH transmissions.

Example A7 may include the method of Example A1 or some other Example herein, wherein for Step 4: the procedure in Step 1 and Step 3 is continued to determine the all the ROs in the second RO group associated with the SSB, assuming that the valid ROs in the first RO group are excluded from the determination of ROs in the second RO group.

Example A8 may include the method of Example A1 or some other Example herein, wherein for Step 5: the procedure in Step 1 to Step 4 is continued to determine all the ROs in the set of RO groups associated with the SSB within the SSB to RO group association patter period.

Example A9 may include the method of Example A1 or some other Example herein, wherein the number of RO groups associated with an SSB in frequency domain may be determined in accordance with the smallest number of ROs in a given time instance that are associated with the same SSB.

Example A10 may include the method of Example A1 or some other Example herein, wherein association pattern period for multiple PRACH transmissions is determined as K SSB to RO association pattern periods, where K is determined as the number of multiple PRACH transmissions. If more than one number of multiple PRACH transmissions is configured by gNB, different K values are determined for different number of multiple PRACH transmissions.

Example A11 may include the method of claim 1, wherein association pattern period for multiple PRACH transmissions is determined as K SSB to RO association pattern periods, where K is determined as smallest or largest value among the number of multiple PRACH transmissions that is configured by the network.

Example A12 may include the method of Example A1 or some other Example herein, wherein association pattern period for multiple PRACH transmissions is determined as K SSB to RO association pattern periods, where K is determined as smallest or largest value among the number of multiple PRACH transmissions that is supported in the specification.

Example A13 may include the method of Example A1 or some other Example herein, wherein association pattern period for multiple PRACH transmissions is determined as K SSB to RO association pattern periods, where K may be determined which depends on whether separate preambles on shared PRACH occasions or separate PRACH occasions are used for the differentiation of different number of multiple PRACH transmissions.

Example A14 may include the method of Example A1 or some other Example herein, wherein for physical downlink control channel (PDCCH) ordered multiple PRACH transmissions, the PRACH mask index is used to indicate the RACH occasion group associated with the SS/PBCH indicated by “SS/PBCH index” for the multiple PRACH transmissions.

Example A15 may include the method of Example A1 or some other Example herein, wherein in case separate preambles on shared ROs are configured to differentiate single and multiple PRACH transmissions, PRACH mask index may be configured to indicate that a subset of PRACH occasions that are configured for single PRACH transmission may be used for multiple PRACH transmissions.

Example A16 may include the method of Example A1 or some other Example herein, wherein in case separate preambles on shared ROs are configured to differentiate multiple PRACH transmissions with different number of repetitions, PRACH mask index may be configured to indicate that a subset of PRACH occasion may be used for multiple PRACH transmissions.

Example A17 may include a method of a user equipment (UE), the method comprising: determining a number of physical random access channel (PRACH) transmissions of multiple PRACH transmissions; determining PRACH occasion (RO) groups for the respective PRACH transmissions based on associated synchronization signal blocks (SSBs); and encoding the multiple PRACH transmissions in one or more of the RO groups.

Example A18 may include the method of Example A17 or some other Example herein, wherein a first RO group of the RO groups is determined to include a number of ROs equal to the number of the multiple PRACH transmissions.

Example A19 may include the method of Example A17-18 or some other Example herein, wherein a first RO group of the RO groups is determined to include ROs that are associated with a same SSB and in different time instances.

Example A20 may include the method of Example A19 or some other Example herein, wherein the number is a first number, and wherein if a second number of the ROs associated with the same SSB in different time instances is less than the first number, then the first RO group is determined to include two or more ROs associated with the SSB that are frequency domain multiplexed in a same time instance.

Example A21 may include the method of Example A20 or some other Example herein, wherein the two or more ROs that are frequency domain multiplexed are separated by a smallest or largest possible frequency range among all ROs that are frequency domain multiplexed in the time instance and associated with the same SSB.

Example A22 may include the method of Example A17-21 or some other Example herein, wherein the RO groups are determined based on association pattern periods for the multiple PRACH transmissions.

Example A23 may include the method of Example A22 or some other Example herein, wherein a number of the association pattern periods is equal to a number of the multiple PRACH transmissions.

Example A24 may include the method of Example A17-23 or some other Example herein, wherein the multiple PRACH transmissions are physical downlink control channel (PDCCH) ordered transmissions.

Example A25 may include the method of Example A24 or some other Example herein, further comprising receiving a PRACH mask index to indicate one or more of the RO groups that are associated with a first SSB.

Example A26 may include the method of Example A25 or some other Example herein, wherein the PRACH mask index indicates that a subset of PRACH occasions that are configured for single PRACH transmission are available for use for multiple PRACH transmissions.

Example Z01 may include an apparatus comprising means to perform one or more elements of a method described in or related to any of examples 1-26, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-26, or any other method or process described herein.

Example Z03 may include an apparatus comprising logic, modules, or circuitry to perform one or more elements of a method described in or related to any of examples 1-26, or any other method or process described herein.

Example Z04 may include a method, technique, or process as described in or related to any of examples 1-26, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-26, or portions thereof.

Example Z06 may include a signal as described in or related to any of examples 1-26, or portions or parts thereof.

Example Z07 may include a datagram, packet, frame, segment, protocol data unit (PDU), or message as described in or related to any of examples 1-26, or portions or parts thereof, or otherwise described in the present disclosure.

Example Z08 may include a signal encoded with data as described in or related to any of examples 1-26, or portions or parts thereof, or otherwise described in the present disclosure.

Example Z09 may include a signal encoded with a datagram, packet, frame, segment, protocol data unit (PDU), or message as described in or related to any of examples 1-26, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-26, or portions thereof.

Example Z11 may include a computer program comprising instructions, wherein execution of the program by a processing element is to cause the processing element to carry out the method, techniques, or process as described in or related to any of examples 1-26, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1-25. (canceled)

26. An apparatus of a New Radio (NR) User Equipment (UE), the apparatus including a processing circuitry and a radio frequency (RF) circuitry interface to couple the processing circuitry to an RF circuitry of the UE, the processing circuitry to:
detect a synchronization signal block (SSB) from a NR Node B (gNB);
determine a number of multiple physical random access channel (PRACH) transmissions, wherein respective PRACH transmissions of the multiple PRACH transmissions correspond to repetitions of each other and to a preamble;
determine a set of valid PRACH occasions associated with the SSB, wherein respective ones of the valid PRACH occasions of the set:
are in sequential respective time instances; and
use same frequency resources as any immediately prior PRACH occasion of the set; and
send the multiple PRACH transmissions in the set for transmission to the gNB.

27. The apparatus of claim 26, wherein the sequential respective time instances correspond to consecutive respective time instances.

28. The apparatus of claim 26, wherein, starting at frame 0 of a time period, a first valid PRACH occasion corresponds to a first valid PRACH occasion of the set.

29. The apparatus of claim 26, wherein the set is a first set, the processing circuitry to further determine a plurality of sets of valid PRACH occasions associated with the SSB, the plurality of sets including the first set.

30. The apparatus of claim 29, where the SSB is a first SSB, the plurality of sets of valid PRACH occasions is a first plurality of sets of valid PRACH occasions, the processing circuitry to: detect a plurality of SSBs including the first SSB; and determine pluralities of sets of valid PRACH occasions including the first plurality of sets of valid PRACH occasions, respective ones of the pluralities of sets of valid PRACH occasions corresponding to a respective one of the plurality of SSBs.

31. The apparatus of claim 26, wherein a number of the repetitions includes one of 2 or 4.

32. The apparatus of claim 26, the processing circuitry to determine the set associated with the SSB within an SSB to PRACH occasion set association pattern period.

33. The apparatus of claim 26, the processing circuitry to determine the set associated with the SSB within an SSB to PRACH occasion set association pattern period.

34. The apparatus of claim 33, further including a memory interface to send or receive data from a memory of the UE.

35. The apparatus of claim 34, further including a radio frequency (RF) circuitry coupled to the processing circuitry.

36. The apparatus of claim 35, further including a front end coupled to the RF circuitry.

37. The apparatus of claim 36, further including one or more antenna elements coupled to the front end, the one or more antenna elements to communicate wireless signals from and to the UE.

38. A method to be performed at an apparatus of a New Radio (NR) User Equipment (UE), the method including:
detecting a synchronization signal block (SSB) from a NR Node B (gNB);
determining a number of multiple physical random access channel (PRACH) transmissions, wherein respective PRACH transmissions of the multiple PRACH transmissions correspond to repetitions of each other and to a preamble;
determining a set of valid PRACH occasions associated with the SSB, wherein respective ones of the valid PRACH occasions of the set:
are in sequential respective time instances; and
use same frequency resources as any immediately prior PRACH occasion of the set; and
send the multiple PRACH transmissions in the set for transmission to the gNB.

39. The method of claim 38, wherein the sequential respective time instances correspond to consecutive respective time instances.

40. The method of claim 38, wherein, starting at frame 0 of a time period, a first valid PRACH occasion corresponds to a first valid PRACH occasion of the set.

41. The method of claim 38, wherein the set is a first set, further including determining a plurality of sets of valid PRACH occasions associated with the SSB, the plurality of sets including the first set.

42. The method of claim 41, where the SSB is a first SSB, the plurality of sets of valid PRACH occasions is a first plurality of sets of valid PRACH occasions, further including:
detecting a plurality of SSBs including the first SSB; and
determining pluralities of sets of valid PRACH occasions including the first plurality of sets of valid PRACH occasions, respective ones of the pluralities of sets of valid PRACH occasions corresponding to a respective one of the plurality of SSBs.

43. The method of claim 38, wherein a number of the repetitions includes one of 2 or 4.

44. A tangible a non-transitory machine-readable storage medium including code which, when executed, is to cause a machine to perform operations including:
detecting a synchronization signal block (SSB) from a NR Node B (gNB);
determining a number of multiple physical random access channel (PRACH) transmissions, wherein respective PRACH transmissions of the multiple PRACH transmissions correspond to repetitions of each other and to a preamble;
determining a set of valid PRACH occasions associated with the SSB, wherein respective ones of the valid PRACH occasions of the set:
are in sequential respective time instances; and
use same frequency resources as any immediately prior PRACH occasion of the set; and
sending the multiple PRACH transmissions in the set for transmission to the gNB.

45. The method of claim 38, wherein the sequential respective time instances correspond to consecutive respective time instances.
